(19) United States
(12) Patent Application Publication
(10) Pub. No.: US 2021/0286876 A1
(43) Pub. Date: Sep. 16, 2021

(54) METHOD FOR PREVENTING COMPUTER ATTACKS IN TWO-PHASE FILTERING AND APPARATUSES USING THE SAME

(71) Applicant: Kuo CHIANG, New Taipei City (TW)

(72) Inventor: Kuo CHIANG, New Taipei City (TW)

(21) Appl. No.: 17/336,899

(22) Filed: Jun. 2, 2021

Related U.S. Application Data
(63) Continuation of application No. 15/770,749, filed on Apr. 24, 2018.

(51) Int. Cl. G06F 21/56; G06F 21/53; G06F 21/57; H04L 29/06; H04L 29/08

(52) U.S. Cl. CPC G06F 21/56; G06F 21/53; G06F 21/577; H04L 67/2814; H04L 63/101; H04L 63/1416; H04L 63/1441; H04L 63/0227

(57) ABSTRACT

The invention introduces a method for preventing computer attacks in two-phase filtering, performed by a processing unit of an apparatus, which contains at least the following steps: receiving service requests from a client system, wherein each service request requests for executing a service in a protected computer-asset in a network; performing a phase one filtering including a white-list judgment, a black-list judgment, and a custom-rule judgment on each service request; and performing a phase two filtering including a base-rule judgement on each service request that has undergone the phase one filtering completely, hasn't been forwarded to the protected computer-asset in the phase one filtering, and hasn't been undergone the attack prevention operation in the phase one filtering. Each custom-rule pattern defines a specific attack to an individual system or vulnerability. Each base-rule pattern defines a common attack. The base-rule patterns cover more types of computer-assets than the custom-rule patterns.

### CROSS-REFERENCE TO RELATED APPLICATIONS

This is a Continuing Patent Application of and claims the benefit of priority to U.S. patent application Ser. No. 15/770,749, filed on Apr. 24, 2018, which is a national stage application, filed under 35 U.S.C. § 371, of International Patent Application No. PCT/US2015/058,158, filed on Oct. 29, 2015, the entirety of which is incorporated herein by reference for all purposes.

### BACKGROUND

The present invention relates to computer security, and in particular, to methods for preventing computer attacks in two-phase filtering and apparatuses using the same.

In the computer security context, hackers seek and exploit weaknesses in a computer system or computer network. Cooperation may suffer from the attacks, such as damaging computer services, breaching personal data of customers, losing profit or reputation, etc. Numerous rules are developed for blocking the attacks from harming computer servers or the computer network and excessive time is consumed to analyze the attack patterns. Thus, it is desirable to have methods for preventing computer attacks in two-phase filtering and apparatuses using the same to block computer attacks efficiently.

### SUMMARY

An embodiment of the invention introduces a method for preventing computer attacks in two-phase filtering, performed by a processing unit of an apparatus, which contains at least the following steps. A service request is received from a client system, which requests a service to a protected computer-asset. The phase one filtering is performed to forward the service request to the protected computer-asset when a white-list pattern is discovered from the service request. The phase two filtering is performed subsequent to a completion of the phase one filtering.

An embodiment of the invention introduces an apparatus for preventing computer attacks in two-phase filtering, which contains at least a storage device and a processing unit. The storage device stores multiple white-list patterns. The processing unit is configured to receive a service request from a client system, which requests a service to a protected computer-asset; perform the phase one filtering to forward the service request to the protected computer-asset when discovering a white-list pattern from the service request; and perform the phase two filtering subsequent to a completion of the phase one filtering.

A detailed description is given in the following embodiments with reference to the accompanying drawings.

### BRIEF DESCRIPTION OF THE DRAWINGS

FIG. 1 is a schematic diagram of the network architecture according to an embodiment of the invention.

FIG. 2 is the system architecture of a router or a gateway according to an embodiment of the invention.

FIG. 3 is a flowchart illustrating a two-phase filtering method according to an embodiment of the invention.

FIG. 4 is a schematic diagram of software modules, being loaded and executed by a processing unit, for dealing with network packets flowed through a gateway or a router according to an embodiment of the invention.

FIG. 5 is the system architecture of a computer apparatus according to an embodiment of the invention; and

FIG. 6 is a schematic diagram of software modules, being loaded and executed by a processing unit, for dealing with service requests from a client system according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

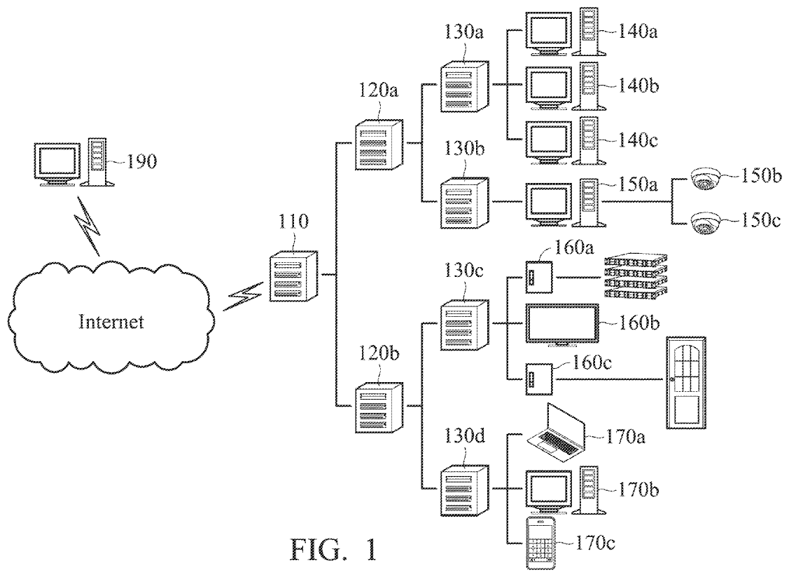

An embodiment of the invention introduces the network architecture for connecting a wide range of protected computer-assets, such as computers, computer servers, monitoring systems, IoT (Internet of Things) devices. FIG. 1 is a schematic diagram of the network architecture according to an embodiment of the invention. Protected computer-assets include servers 140a to 140c, the monitoring system inclusive of the monitor host 150a with surveillance cameras 150b and 150c, the IoT devices, such as the bulb control system 160a, the smart TV (television) 160b, the lock control system 160c, etc., and client computers, such as the notebook computer 170a, the personal computer 170b, the tablet computer 170c, etc. The server 140a, 140b or 140c may be a web server, an application server, an email server, an IM (Instant Messaging) server, a NAS (Network-attached storage) server, or others. The web server may store, generate and deliver web pages to clients. The communication between a client and the web server takes place using the HTTP (Hypertext Transfer Protocol) or other protocols. Web pages delivered are most frequently HTML (Hyper-Text Markup Language) documents, which may include images, style sheets and scripts in addition to text content. The application server may be a software framework that provides both facilities to create web applications and a server environment to run the web applications. The application server framework may contain a comprehensive service layer model. The application server may operate as a set of components accessible to the software developer through an API (Application Programming Interface) defined by the platform itself. For Web applications, the components may be performed in the same running environment as its web server, and their main task is to support the construction of web pages. The components may implement services like clustering, fail-over, and load-balancing, such that software developers can focus on implementing the business logic. The email server may receive an email from a mail client using SMTP (Simple Mail Transfer Protocol) for relaying and deliver an email to the mail client using either POP3 (Post Office Protocol version 3) or IMAP (Internet Message Access Protocol). The IM server may facilitate communication among one or more participants, allowing immediate receipt of acknowledgment or reply. The NAS server may provide data access to a heterogeneous group of clients, which contains one or more hard drives arranged into logical, redundant storage containers or RAID (Redundant Array of Independent Disks). Surveillance cameras 150b and 150c may be video cameras used to observe an area and the monitoring host 150a may include a recording device for recording and compressing the images captured by the surveillance cameras 150b and 150c and storing the compact videos in a searchable database. The IoT devices 160a to 160c may be physical devices embedded with electronics, software, sensors, and connectivity to enable the devices to exchange data with the other connected devices. The IoT devices may allow devices to be sensed and controlled remotely across the network infrastructure. A client system 190 connecting to the Internet may send requests requesting services to any of the protected computer-assets 140a to 170c. The above list is not exhaustive, and it will be understood that other servers, IoT devices or computer systems can be protected.

Each of the protected computer-assets 140a to 170c are connected to one of the hubs 130a to 130d. Each hub is a device for connecting multiple Ethernet devices together and making them operate like a single network segment. The hub has multiple I/O (Input/Output) ports, in which a signal introduced at the input of any port appears at the output of every port except the original incoming. Any of the hubs 130a to 130d may be alternatively replaced with an AP (Access Point). The AP allows the protected computer-assets 140a to 170c to connect to a wired network using Wi-Fi, or related standards. Each of the routers 120a to 120b forwards network packets between computer networks. A network packet is typically forwarded from one router to another through the networks that constitute the internetwork until it reaches its destination node. The router is connected to two or more data lines from different networks. When a network packet comes in on one of the lines, the router reads the address information in the packet to determine its ultimate destination. Then, using information in its routing table or routing policy, the router directs the network packet to the next network. The routers 120a to 120b may be home or small office routers that simply pass data, such as web pages, email, IM (Instant Messages), audio streams, video streams, etc., between the protected computer-assets 140a to 170c and the Internet. The home or small office router may be the cable or DSL (Digital Subscriber Line) router, which connects to the Internet through an ISP (Internet service provider). Any of the routers 120a to 120b may alternatively be an enterprise router to connect large business or ISP networks up to the powerful core routers that forward data at high speed along the optical fiber lines of the Internet backbone. The gateway 110 may operate as a proxy server and a firewall server. The gateway 110 may integrate with functionalities of both a router, which knows where to direct a given network packet that arrives at the gateway 110, and a switch, which furnishes the actual path in and out of the gateway 110 for a given packet.

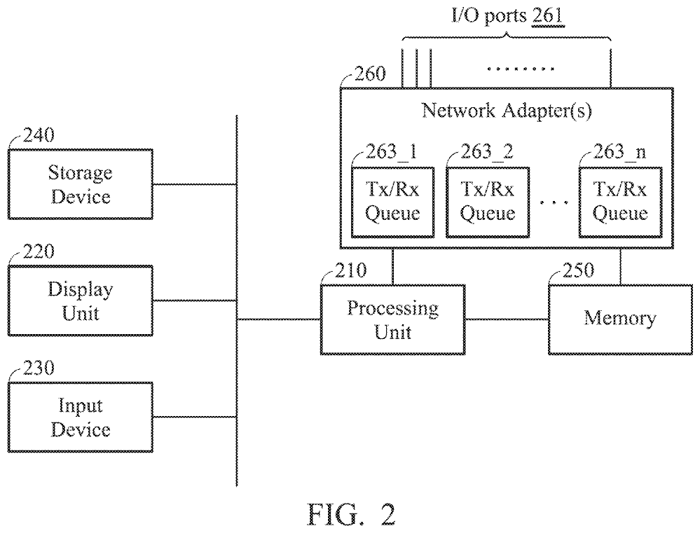

FIG. 2 is the system architecture of a router or a gateway according to an embodiment of the invention. The system architecture may be practiced in any of the gateway 110 and the routers 120a and 120b. The gateway 110 or the router 120a or 120b is configured to receive network packets and, ultimately, determine an output node to transmit the network packets out of the gateway 110 or the router 120a or 120b. The processing unit 210 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The system architecture further includes the memory 250 for storing necessary data in execution, such as variables, data tables, data abstracts, or others, and the storage device 240 for storing a white list, a wide range of filtering rules, such as custom rules, base rules, or others. The system architecture further includes one or more input devices 230 to receive user input, such as a keyboard, a mouse, a touch panel, or others. A user may press hard keys on the keyboard to input characters, control a mouse pointer on a display by operating the mouse, or control an executed application with one or more gestures made on the touch panel. The gestures include, but are not limited to, a one-click, a double-click, a single-finger dragging, and a multiple finger dragging. The display device 220, such as the TFT-LCD (Thin film transistor liquid-crystal display) panel, the OLED (Organic Light-Emitting Diode) panel, or others, may also be included to display input letters, alphanumeric characters and symbols, dragged paths or drawings for a user's viewing. The network adapter(s) 260 may be configured to communicate using an Ethernet communications capable of permitting communication using a TCP/IP (Transmission Control Protocol/Internet Protocol), UDP (User Datagram Protocol), and/or other communications protocols. The network adapter(s) 260 include multiple ports 261 and each port 261 may be configured as an internal port or an external port. The network adapter(s) 260 may include multiple Tx/Rx (transmit and/or receive) queues 263-1 to 263-n configured to cache network data, which will be transmitted and/or has been received.

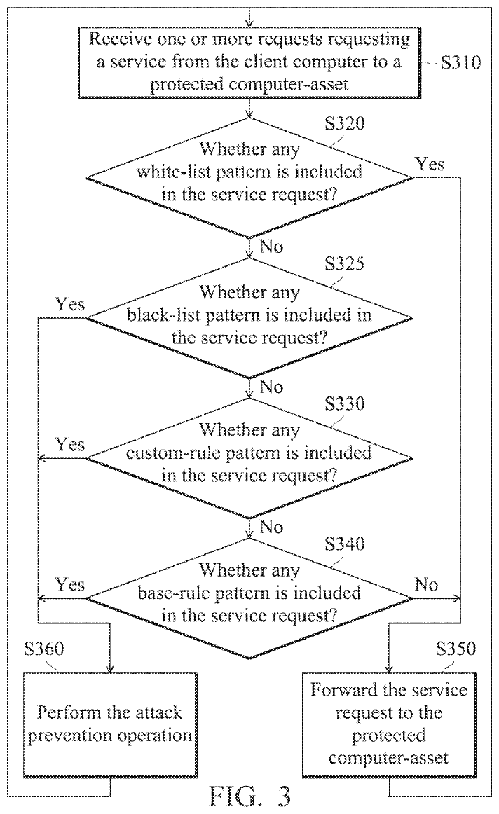

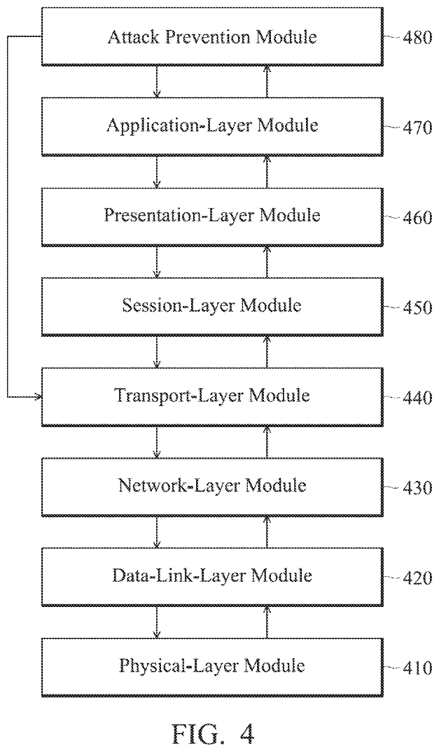

To prevent computer attacks from damaging the protected computer-assets 140a to 170c, an embodiment of a two-phase filtering method is introduced to examine network packets including various service requests, which are flowed through the gateway 110 or the router 120a or 120b, in the efficient manner and perform an attack prevention operation once detecting that any network packet includes an attack pattern. The method is performed by the gateway 110 or the router 120a or 120b when the processing unit 210 thereof loads and executes relevant software code or instructions with predefined patterns. FIG. 3 is a flowchart illustrating a two-phase filtering method according to an embodiment of the invention. The method may examine layer 7 (so-called application layer) messages encapsulated in the flowed network packets to detect the attack patterns. Each service request may include a destination address, a port number, request messages, executable scripts, form objects, post actions, executable program-uploads, or any combinations thereof. FIG. 4 is a schematic diagram of software modules, being loaded and executed by the processing unit 210, for dealing with network packets flowed through the network adapter(s) 260 of the gateway 110 or the router 120a or 120b according to an embodiment of the invention. The software modules 410 to 470 may follow the specification of the OSI model (Open Systems Interconnection model) to extract data or messages layer by layer. The OSI model characterizes and standardizes the communications of a telecommunication or computing system without regard of their underlying internal structure and technology. The physical-layer module 410, the data-link-layer module 420, the network-layer module 430 and the transport-layer module 440 may be practiced in the network adapter(s) 260. The physical-layer module 410 may establish and terminate a connection between two directly connected nodes over a communications medium. The electrical and physical specifications of the data connection may include the layout of pins, voltages, line impedance, cable specifications, signal timing or more. The data-link-layer module 420 may provide node-to-node data transfer, a reliable link between two directly connected nodes, by detecting and possibly correcting errors that may occur in the physical layer. The data link layer may be divided into two sublayers: MAC (Media Access Control) layer, which is responsible for controlling how devices in a network gain access to data and permission to transmit it; and LLC (Logical Link Control) layer, which controls error checking and packet synchronization. The network-layer module 430 may provide the functional and procedural means of transferring variable length data sequences (called datagrams) from one node to another. The network-layer module 430 may translate logical network addresses into physical machine addresses. Every node has an address, which permits one node connected to the network to transfer messages to other nodes connected to the network by merely providing the content of a message and the address of the destination node and letting the gateway 110 or the router 120a or 120b find the way to deliver (“route”) the message to the destination node. In addition to message routing, the network-layer module 430 may implement message delivery by splitting the message into several fragments, delivering each fragment by a separate route and reassembling the fragments, report delivery errors, etc. The transport-layer module 440 may control the reliability of a given link through flow control, segmentation/de-segmentation, and error control. The transport-layer module 440 may keep track of the segments and retransmit those that fail. The transport-layer module 440 may also provide the acknowledgement of the successful data transmission and send the next data if no errors occurred. The transport-layer module 440 may create packets out of the message received from the application-layer module 470. The transport-layer protocol employed in the transport-layer module 440 may be TCP (Transmission Control Protocol), usually built on top of IP (Internet Protocol). The session-layer module 450, the presentation-layer 460 and the application-layer module 470 may be practiced in software code or instructions, which are loaded and executed by the processing unit 210. The session-layer module 450 may establish, manage and terminate the connections between the local and remote application. The presentation-layer module 460 may establish context between application-layer entities, in which the application-layer entities may use different syntax and semantics if the presentation service provides a mapping between them. If a mapping is available, presentation service data units are encapsulated into session protocol data units, and passed down the protocol stack. The application-layer module 470 may provide independence from data representation (e.g., encryption) by translating between application and network formats. The application-layer module 470 may transform data into the form that the application accepts. For example, the application-layer module 470 may extract or translate request messages (so-called layer 7 messages), such as HTTP, HTTPS (Secure Hypertext Transfer Protocol), WAP (Wireless Application Protocol), FTP (File Transfer Protocol), LDAP (Lightweight Directory Access Protocol), DNS (Domain Name System), SSH (Secure Shell) requests, etc., from or into IP packets. The method continuously receives one or more requests requesting a service from the client system 190 to a protected computer-asset, such as any of the protected computer-assets 140a to 170c, via the network adapter 260 (step S310). The two-phase filtering method illustrated in FIG. 3 may be implemented in the attack prevention module 480. In step S310, the attack prevention module 480 may receive the service requests from the application-layer module 470.

Following the receipt of the service requests (step S310), two-phase filtering is performed. In phase one, at least one of three judgements are included. The first one determines whether any white-list pattern is included in each service request (step S320). The white-list patterns added or updated by a user may be regular expressions or other expression languages. The white-list patterns are read from the storage device 240 and provided to facilitate the speed of making decisions and avoid false positives. That is, the processing unit 210 simply bypasses service requests having white-list patterns, without detecting anything further. The second one determines whether any black-list pattern is included in each service request (step S325). The black-list patterns added or updated by a user may include a specific source IP address, an uri, or others. The black-list pattern are read from the storage device 240 and provided to facilitate the speed of making decisions. That is, the processing unit 210 directly performs an attack prevention operation. The third one determines whether any custom-rule pattern is included in each service request (step S330). The custom-rule patterns are stored in the storage device 240 and are added, modified or reinforced with particular types of protected computer-assets, such as the web server, the application server, the IM server, the NAS server, the email server, the monitoring system, the IoT device, the client computer, etc. The custom-rule patterns may be considered as enhanced patterns for particular types of protected computer-assets. For example, if the corporation mainly protects web servers from being damaged, custom-rule patterns related to the web servers are provided to filter out possible attacks to the web servers. Once discovering the white-list pattern (the “Yes” path of step S320), the processing unit 210 executing the attack prevention module 480 forwards the service request to the protected computer-asset (step S350). Specifically, the transport-layer module 440 may cache the network packets corresponding to each service request, such as TCP/IP packets with a destination IP address, in the memory 250 (step S310), and, after discovering the white-list pattern (the “Yes” path of step S320), the attack prevention module 480 may direct the transport-layer module 440 to transmit the cached network packets down to the protocol stack, thereby enabling the service request enclosed in the network packets to be forwarded to the protected computer-asset, without re-generating network packets using the presentation-layer module 460 and the session-layer module 450 (step S350). Alternatively, the attack prevention module 480 may transmit the service request down to the presentation-layer module 460 directly, thereby enabling the service request to be forwarded to the protected computer-asset (step S350). Once discovering no white-list pattern (the “No” path of step S320) but the black-list pattern (the “Yes” path of step S325), the processing unit 210 executing the attack prevention module 480 performs the attack prevention operation (step S360). Once discovering none of the white-list pattern and the black-list pattern (the “No” path of step S325 following the “No” path of step S320) but the custom-rule pattern (the “Yes” path of step S330), the processing unit 210 executing the attack prevention module 480 performs the attack prevention operation (step S360). The custom-rule patterns are specifically designed for protected systems or existing vulnerability. In an example, the custom-rule pattern contains a string “a=2147483647”, which may trigger specific application errors, and the processing unit 210 performs the attack prevention operation after detecting that the string is included in the request message “HTTP-GET: http://www.example.com/index.php?a=2147483647” of the service request. In still another example, the custom-rule pattern contains a permitted quantity of login attempts in the predetermined time period, and the processing unit 210 performs the attack prevention operation after detecting that the number of attempts the client system 190 made to log in the protected computer asset in the predetermined time period exceeds the permitted quantity. In still another example, the custom-rule pattern decodes and checks messages encoded by base64, and the processing unit 210 performs the attack prevention operation by detecting that the decoded service request includes malicious contents. In still another example, the custom-rule pattern contains patterns to protect a specific IoT device, which is deployed and its vulnerability is identified. Although the three judgements appear to occur in a specific order, those skilled in the art may devise the order depend on design requirements and the invention should not be limited thereto.

Once discovering no white-list pattern (the “No” path of step S320), no black-list pattern (the “No” path of step S3325) and no custom-rule pattern (the “No” path of step S330), the second phase filtering is performed. In phase two, the processing unit 210 determines whether any base-rule pattern is included in each service request (step S340). The base-rule patterns are stored in the storage device 240 and provided to prevent common and critical attacks from damaging the protected computer-assets. The base-rule patterns are not specifically designed for individual system or vulnerability. The base-rule patterns are used to prevent common attacks. The base-rule patterns may be updated periodically, such as per day, once a week, etc., to respond to the newly detected attack behaviors. The processing unit 210 executing the attack prevention module 480 forwards the service request to the protected computer-asset (step S350) when no base-rule pattern is discovered in the service request (the “No” path of step S340). In step S350, as discussed above, the attack prevention module 480 may forward the service request to the protected computer asset by directing the transport-layer module 440 to transmit the cached network packets down to the protocol stack or transmitting the service request down to the presentation-layer module 460 directly. The processing unit 210 executing the attack prevention module 480 performs the attack prevention operation (step S360) when the base-rule pattern is discovered in the service request (the “Yes” path of step S340). In an example, the base-rule pattern contains a string “or 1=1--” and the processing unit 210 performs the attack prevention operation after detecting that the string is included in the executable scripts of the service request. In another example, the base-rule pattern contains a string “><script>alert(‘0’);</script>” and the processing unit 210 performs the attack prevention operation after detecting that the string is included in the request message of the service request. In still another example, the base-rule pattern contains the permitted quantity of characters of the request message of the service request and the processing unit 210 performs the attack prevention operation after detecting that the length of the request message exceeds the permitted quantity, as it may be buffer-overflow attacks. In an embodiment of the attack prevention operation, special characters of the request message of the service request, by which a trigger of the execution of malicious attack scripts is bracketed, are replaced with equivalent strings, for example, special characters “<” and “>” may be replaced with “&lt” and “&gt” respectively and the modified request message is forwarded to the protected computer asset. Those skilled in the art understood that no execution of malicious scripts can be triggered when the trigger is bracketed by strings “&lt” and “&gt”. That is, the special characters are replaced to prevent the strings from switching into any execution context. In another embodiment, service requests containing the detected custom-rule patterns or base-rule patterns are dropped, without forwarding them to the protected computer-assets. In still another embodiment, service requests containing the detected custom-rule patterns or base-rule patterns are blocked from being forwarded to the protected computer-asset and messages are responded to the client system 190. The message may be “HTTP 500—Internal Server Error”, “HTTP 403—Forbidden”, “HTTP 200—OK”, or others. In still another embodiment, service requests containing the detected custom-rule patterns or base-rule patterns are forwarded to the protected computer-asset and logs describing the detection times with the discovered custom-rule patterns or base-rule patterns and other relevant information are recorded. In still another embodiment, an url (uniform resource locator) linking to a warning web page is responded to the client system 190, thereby enabling users to browse the warning web page. The warning web page may show a warning of the illegal or un-safe access. In still another embodiment, service requests containing the detected custom-rule patterns or base-rule patterns are forwarded to a destination site of a sandbox, in which the damages are controlled in a limited scope. It should be understood that the attack prevention module 480 may examine request messages, executable scripts, form objects, post actions, executable program-uploads, or others of the service requests to determine whether any white-list pattern, custom-rule pattern or base-rule pattern is included therein as described in the aforementioned step S320, S330 or S340. The white-list and black-list patterns, the custom-rule patterns and the base-rule patterns are stored in the storage device 240 or loaded in the memory 250.

The introduced method can be applied to reduce the damages caused by SQL (Structured Query Language) injection attacks, XSS (Cross-Site Scripting) attacks, path traversal attacks, command injection attacks, buffer overflow attacks, CSRF (Cross-Site Request Forgery) attacks, or others. A SQL injection attack consists of insertion of a SQL query. A successful SQL injection exploit may read sensitive data from the database, modify database data, such as Insert, Update or Delete, execute administration operations on the database, such as shutdown the DBMS (Database Management System), recover the content of a given file present on the DBMS file system and in some cases issue commands to the operating system. XSS attacks may inject malicious scripts into trusted web servers, so-called persistent XSS attacks. XSS attacks may occur when an attacker uses a web application to send malicious code, generally in the form of a browser side script, to a different end user, so-called reflected XSS attacks. A path traversal attack attempts to access files and directories that are stored outside the web root folder. By visiting the directories, the attacker looks for absolute links to files stored in the web server, the application, the email server, the IM server, the NAS server, or others. By manipulating variables that reference files with “dot-dot-slash (../)” sequences and its variations, it may access arbitrary files and directories stored in the file system, including application source code, configuration and critical system files, limited by system operational access control. The attacker may use “../” sequences to move up to root directory, thus permitting navigation through the file system. The sequences for traversing directories may be carried in the service request, for example, “http://www.test.com/../../../”. A command injection attack executes arbitrary commands on the host OS (operating system) via a vulnerable application. Command injection attacks are possible when an application passes unsafe user supplied data (forms, cookies, HTTP headers etc.) to a system shell. A buffer overflow attack uses buffer overflows to corrupt the execution stack of a web server or an application server. By sending carefully crafted input to a web application, an attacker can cause the web application to execute arbitrary code to cause buffer overflows. A CSRF attack forces an user to execute unwanted actions on a web application in which they are currently authenticated. With the help of a social application (such as sending a link via email or chat), an attacker may trick the users of a web application into executing actions of the attacker's choosing. If the victim is a normal user, a successful CSRF attack may force the user to perform state changing requests like transferring funds, changing their email address or password, and so on. If the victim is an administrative account, CSRF may compromise the entire web application.

As reflected to the aforementioned phase-two filtering, the base-rule patterns cover as many attack behaviors of all kinds as possible. In other words, the base-rule patterns cover more types of protected computer-assets than the custom-rule patterns. Moreover, the base-rule patterns may prevent some types of vulnerability, which does not present in the corporation network. The rules are not specifically designed for an individual system. For example, the corporation network has no IoT devices and the base-rule patterns contain patterns that can provide general attack prevention for IoT devices. It should be noted that the corporation network might have IoT devices in the future and it is necessary to have base-rule patterns to prevent the computer attacks against IoT devices. However, it may take excessive time to pass the inspection associated with the base-rule patterns by examining the content of service requests thoroughly. The phase-one filtering inclusive of the white-list pattern and custom-rule patterns inspections is provided prior to the phase-two filtering. The custom-rule patterns are served for limited kinds of protected computer-assets, which are resident behind the gateway 110 or the router 120a or 120b. The customs rules are designed specifically for computer assets or software vulnerability in place. They may be different according to the protected systems. In one hand, the service requests are forwarded to the destination instantly once any white-list pattern is discovered, without inspecting anything further. There may be also a black-list pattern, which blocks attackers at early stage, for example, based on IP addresses. On the other hand, the attack prevention operation is performed instantly after any custom-rule pattern is discovered.

Although the embodiments describe that the custom-rule patterns are used in the phase one filtering and the base-rule patterns are used in the phase two filtering, those skilled in the art may swap the applied patterns. In other words, steps S330 and S340 can be swapped depending on different requirements. For example, when the corporation network faces more common attacks than attacks against specific protected computer-assets, systems or vulnerability, the base-rule patterns are applied in the phase one filtering while the custom-rule patterns are applied in the phase two filtering.

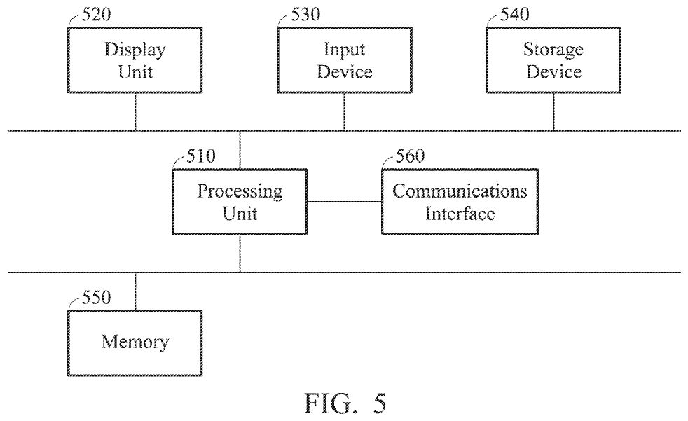

FIG. 5 is the system architecture of a computer apparatus according to an embodiment of the invention. The system architecture may be practiced in any of the servers 140a to 140c, the monitor host 150a, the IoT devices 160a to 160c, the client computers 170a to 170c and the like with computation capacity, at least including a processing unit 510. The processing unit 510 can be implemented in numerous ways, such as with dedicated hardware, or with general-purpose hardware (e.g., a single processor, multiple processors or graphics processing units capable of parallel computations, or others) that is programmed using microcode or software instructions to perform the functions recited herein. The system architecture further includes a memory 550 for storing necessary data in execution, such as variables, data tables, data abstracts, or others, and a storage unit 240 for storing a white list, a wide range of filtering rules, such as custom rules, base rules, or others, and a wide range of electronic files, such as Web pages, documents, video files, audio files, and others. A communications interface 560 is included in the system architecture and the processing unit 510 can thereby communicate with other electronic apparatuses. The communications interface 560 may be a LAN (Local Area Network) module, a WLAN (Wireless Local Area Network) module, or others with the communications capability with the routers 120a to 120b. The system architecture further includes one or more input devices 530 to receive user input, such as a keyboard, a mouse, a touch panel, or others. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. A display unit 520, such as a TFT-LCD (Thin film transistor liquid-crystal display) panel, an OLED (Organic Light-Emitting Diode) panel, or another display unit, may also be included to display input letters, alphanumeric characters and symbols, dragged paths, drawings, or screens provided by an application for a user to view.

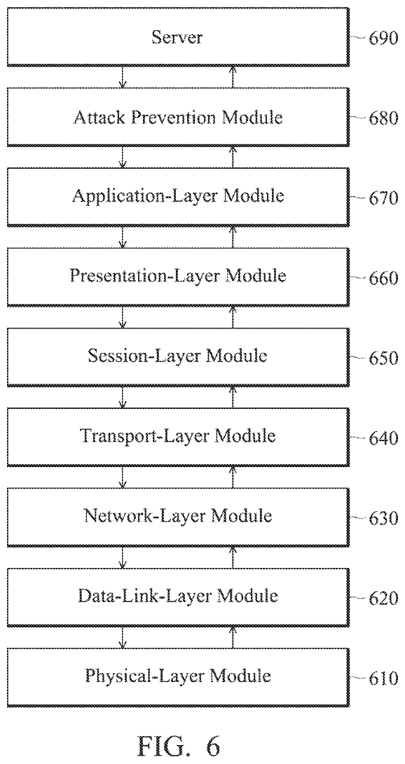

To prevent computer attacks from damaging the protected computer-assets 140a to 170c, the introduced embodiment of the two-phase filtering method may be performed in the servers 140a to 140c, the monitor host 150a, the IoT devices 160a to 160c, the client computers 170a to 170c and the like with computation capacity to examine service requests in the efficient manner before the service requests are sent to a server, such as the web server, the application server, the IM server, the NAS server, the email server, etc., and perform an attack prevention operation once detecting that any service request includes an attack pattern. The method may be devised according to the flowchart of FIG. 3 and is performed by any of the servers 140a to 140c, the monitor host 150a, the IoT devices 160a to 160c, the client computers 170a to 170c and the like with computation capacity when the processing unit 210 thereof loads and executes relevant software code or instructions with predefined patterns. FIG. 6 is a schematic diagram of software modules, being loaded and executed by the processing unit 510, for dealing with service requests from a client system according to an embodiment of the invention. Details of software modules 610 to 670 may refer to the descriptions of steps 410 to 470. The server 690 may perform functionality of the web server, the application server, the IM server, the NAS server, the email server, the monitoring system, the IoT device, or others. The attack prevention module 680 may be placed between the application-layer module 670 and the server 690. The revised method may examine layer 7 (so-called application layer) messages, such as examine request messages, executable scripts, form objects, post actions, executable program-uploads, or others of the service requests, to detect the attack patterns. The attack prevention module 680 may devise step S350 of FIG. 3 to send the service request up to the server 690 when any white-list pattern has been found therein (the “Yes” path of step S320) or no white-list pattern, no black-list pattern, no custom-rule pattern and no base-rule pattern has been found in the service request (the “No” path of step S340 following the “No” path of step S330 following the “No” path of step S325 following the “No” path of step S320).

Although the embodiment has been described as having specific elements in FIGS. 2 and 5, it is noted that additional elements may be included to achieve better performance without departing from the spirit of the invention. While the process flow described in FIG. 3 includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for preventing computer attacks in two-phase filtering, performed by a processing unit of an apparatus, comprising:
receiving a plurality of service requests from a client system, wherein each service request requests for executing a service in a protected computer-asset in a network;
performing a phase one filtering comprising a white-list judgment, a black-list judgment, and a custom-rule judgment on each service request, wherein each service request comprising any of plurality of white-list patterns is forwarded to the protected computer-asset when the white-list judgment is executed, each service request comprising any of plurality of black-list patterns is undergone an attack prevention operation when the black-list judgement is executed, and each service request comprising any of plurality of custom-rule patterns is undergone the attack prevention operation when the custom-rule judgment is executed; and
performing a phase two filtering comprising a base-rule judgement on each service request that has undergone the phase one filtering completely, hasn't been forwarded to the protected computer-asset in the phase one filtering, and hasn't been undergone the attack prevention operation in the phase one filtering, wherein each service request comprising none of plurality of base-rule patterns is forwarded to the protected computer-asset when the base-rule judgement is executed, and each service request comprising any of the base-rule patterns is undergone the attack prevention operation when the base-rule judgment is executed,
wherein the custom-rule judgment examines content of each service request to discover whether any custom-rule pattern is presented in each service request, and each custom-rule pattern defines a specific attack to an individual system or vulnerability,
wherein the base-rule judgment examines content of each service request to discover whether any base-rule pattern is presented in each service request, and each base-rule pattern defines a common attack,
wherein the base-rule patterns cover more types of computer-assets than the custom-rule patterns.

2. The method of claim 1, wherein the base-rule patterns are periodically updated to respond to newly detected attack behaviors.

3. The method of claim 1, wherein the base-rule patterns are used to cover a computer asset that is not presented in the network.

4. The method of claim 1, wherein the attack prevention operation is performed to avoid that the protected computer-asset from being damaged when a requested service is executed in the protected computer-asset.

5. The method of claim 1, wherein the service request comprises a layer 7 message.

6. The method of claim 1, wherein each service request is carried by a Transmission Control Protocol/Internet Protocol (TCP/IP) packet, the method comprising:
caching the TCP/IP packet for each service request; and
forwarding a cached corresponding TCP/IP packet to the protected computer-asset when detecting each service request comprising any white-list pattern, or detecting each service request comprising none of the white-list patterns, the black-list patterns, the custom-rule patterns, and the base-rule patterns.

7. The method of claim 1, wherein the attack prevention operation is performed to replace special characters to prevent strings from switching into any execution context, and forward a modified service request to the protected computer-asset.

8. The method of claim 1, wherein the attack prevention operation is performed to drop the service request directly.

9. The method of claim 1, wherein the attack prevention operation is performed to block the service request from being forwarded to the protected computer-asset, and respond with a message to the client system.

10. The method of claim 1, wherein the attack prevention operation is performed to forward the service request to the protected computer-asset and record a log describing a detection time with a discovered custom-rule pattern or a discovered base-rule pattern.

11. The method of claim 1, wherein the attack prevention operation is performed to respond to the client system with a uniform resource locator (url) linking to a warning web page.

12. The method of claim 1, wherein the attack prevention operation is performed to forward the service request to a destination site of a sandbox.

13. An apparatus for preventing computer attacks in two-phase filtering, comprising:
a storage device, storing a plurality of white-list patters, a plurality of black-list patterns, a plurality of custom-rule patterns, and a plurality of base-rule patterns; and
a processing unit, coupled to the storage device, configured to receive a plurality of service requests from a client system, wherein each service request requests for executing a service in a protected computer-asset in a network; perform a phase one filtering comprising a white-list judgment, a black-list judgment, and a custom-rule judgment on each service request, wherein each service request comprising any white-list pattern is forwarded to the protected computer-asset when the white-list judgment is executed, each service request comprising any black-list pattern is undergone an attack prevention operation when the black-list judgement is executed, and each service request comprising any custom-rule pattern is undergone an attack prevention operation when the custom-rule judgment is executed; and perform a phase two filtering comprising a base-rule judgement on each service request that has undergone the phase one filtering completely, hasn't been forwarded to the protected computer-asset in the phase one filtering, and hasn't been undergone the attack prevention operation in the phase one filtering, wherein each service request comprising any base-rule pattern is undergone the attack prevention operation when the base-rule judgment is executed, and each service request comprising none of base-rule patterns is forwarded to the protected computer-asset when the base-rule judgement is executed,
wherein the custom-rule judgment examines content of each service request to discover whether any custom-rule pattern is presented in each service request, and each custom-rule pattern defines a specific attack to an individual system or vulnerability,
wherein the base-rule judgment examines content of each service request to discover whether any base-rule pattern is presented in each service request, and each base-rule pattern defines a common attack,
wherein the base-rule patterns cover more types of computer-assets than the custom-rule patterns.

14. The apparatus of claim 13, wherein the base-rule patterns are periodically updated to respond to newly detected attack behaviors.

15. The apparatus of claim 13, wherein the base-rule patterns are used to cover a computer asset that is not presented in the network.

16. The apparatus of claim 13, wherein the attack prevention operation is performed to replace special characters to prevent strings from switching into any execution context, and forward a modified service request to the protected computer-asset.

17. The apparatus of claim 13, wherein the attack prevention operation is performed to drop the service request directly.

18. The apparatus of claim 13, wherein the attack prevention operation is performed to block the service request from being forwarded to the protected computer-asset, and respond with a message to the client system.

19. The apparatus of claim 13, wherein the attack prevention operation is performed to forward the service request to the protected computer-asset and record a log describing a detection time with a discovered custom-rule pattern or a discovered base-rule pattern.

20. The apparatus of claim 13, wherein the attack prevention operation is performed to forward the service request to a destination site of a sandbox.
